(19) United States
(12) Patent Application Publication
(10) Pub. No.: US 2017/0278010 A1
(43) Pub. Date: Sep. 28, 2017

(54) METHOD AND SYSTEM TO PREDICT A COMMUNICATION CHANNEL FOR COMMUNICATION WITH A CUSTOMER SERVICE

(71) Applicant: XEROX CORPORATION, Norwalk, CT (US)

(72) Inventors: Narayanan Unny Edakunni, Bangalore (IN); Sainyam Galhotra, Chandigarh (IN)

(21) Appl. No.: 15/077,085

(22) Filed: Mar. 22, 2016

(51) Int. Cl. G06N 99/00; G06Q 30/00; H04L 12/26

(52) U.S. Cl. CPC G06N 99/005; H04L 43/0876; G06Q 30/016

(57) ABSTRACT

The disclosed embodiments illustrate methods and systems for prediction of a communication channel for communication with customer service. The method includes monitoring, by one or more sensors in a server, a communication involving at least a first user for a pre-defined time period. The one or more types of communication channels being used by at least the first user over the pre-defined time period and/or the one or more types of problems reported by at least the first user, is monitored. The method further includes generating, by one or more processors of the server, a temporal data based on the monitoring. The classifier is trained by the one or more processors, based on the generated temporal data. The classifier predicts a likelihood of selection of a type of communication channels from the one or more types of communication channels, for communication between the first user and the server.

### TECHNICAL FIELD

The presently disclosed embodiments are related, in general, to a communication system. More particularly, the presently disclosed embodiments are related to methods and systems for prediction of a communication channel for communication with a customer service.

### BACKGROUND

In the field of customer care services, customer satisfaction is paramount. Therefore, predicting actions of a customer and taking pre-emptive steps to address a query of the customer is imperative for customer satisfaction that translates into revenue. Further, to increase the revenue, there is a need on part of a customer care service provider, to encourage the customer to use a communication channel that is not cost intensive. The cost of the communication channel may be based on an amount of interaction required for communicating over the communication channel. In order to efficiently utilize the resources of the call center, it may be desirable to encourage a customer to utilize a low cost communication channel that requires minimum interaction for communication.

Further, predicting a likelihood of a customer making a call to a customer care service may assist the customer care service provider to select the low cost communication channel. However, presently the prediction is based on data associated with the customer, the nature of which is static over a period of time. Thus, predicting temporal evolution of the customer over the period of time and prediction of a likelihood of selection of a type of communication channel (preferably low cost) from one or more types of communication channels, for communication between a first user and a server may be a challenging task.

Further limitations and disadvantages of conventional and traditional approaches will become apparent to those skilled in the art, through a comparison of described systems with some aspects of the present disclosure, as set forth in the remainder of the present application and with reference to the drawings.

### SUMMARY

According to the embodiments illustrated herein, there may be provided a method for prediction of a communication channel for communication with a customer service. The method may include monitoring, by one or more sensors in a server, a communication involving at least a first user for a pre-defined time period. The one or more types of communication channels being used by at least the first user over the pre-defined time period and/or the one or more types of problems reported by at least the first user, is monitored. The method may further include generating, by one or more processors of the server, a temporal data based on the monitoring. The classifier may be trained by the one or more processors, based on the generated temporal data. The classifier may predict a likelihood of selection of a type of communication channels from the one or more types of communication channels, for communication between the first user and the server.

According to the embodiments illustrated herein, there may be provided a system for prediction of a communication channel for communication with a customer service. The system may include one or more processors in a server. The one or more servers may be configured to monitor a communication involving at least a first user for a pre-defined time period. The one or more types of communication channels being used by at least the first user over the pre-defined time period and/or the one or more types of problems reported by at least the first user, are monitored by the one or more processors of the server. The system may further include generation, by the one or more processors of the server, a temporal data based on the monitoring. The classifier may be trained by the one or more processors, based on the generated temporal data. The classifier may predict a likelihood of selection of a type of communication channels from the one or more types of communication channels, for communication between the first user and the server.

According to the embodiments illustrated herein, there may be provided a computer program product for use with a computing device. The computer program product comprises a non-transitory computer readable medium, the non-transitory computer readable medium stores a computer program code, executable by one or more microprocessors, for prediction of a communication channel for communication with a customer service. The computer program code that is executable by one or more microprocessors may be stored in a server. The computer program code is executable by one or more microprocessors to monitor a communication involving at least a first user for a pre-defined time period. The one or more types of communication channels being used by at least the first user over the pre-defined time period and/or the one or more types of problems reported by at least the first user, are monitored by the one or more processors of the server. The computer program code is executable by one or more microprocessors to generate a temporal data based on the monitoring. The classifier may be trained by the one or more processors, based on the generated temporal data. The classifier may predict a likelihood of selection of a type of communication channels from the one or more types of communication channels, for communication between the first user and the server.

### BRIEF DESCRIPTION OF DRAWINGS

The accompanying drawings illustrate the various embodiments of systems, methods, and other aspects of the disclosure. Any person with ordinary skill in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a network environment in which various embodiments may be implemented;

FIG. 2 is a block diagram illustrating an application server, in accordance with at least one embodiment;

FIG. 3 is a flowchart illustrating a method for predicting a communication channel for communication between a customer and a customer care agent, in accordance with at least one embodiment; and

FIG. 4 is an example illustrating a method for managing a conversation between a first user and a customer care agent, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation, but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the meanings set forth below.

A “communication channel” refers to a physical or logical link to establish a communication session or a semi-permanent connection. The communication channel is used to transmit/receive an information signal between a first user and a second user.

“One or more types of communication channels” refer to a plurality of communication channels that may be used by the customer to establish communication with the customer care service. The one or more types of communication channels may correspond to an e-mail, a mobile based call, a Public Switched Telephone Network (PSTN) call, a software based service request, a software based chat, and a video call.

A “first user” refers to a customer that may initiate an establishment of a communicative connection with a server that corresponds to a customer care service. In an embodiment, the first user may establish connection with a second user that may be associated with the server.

A “second user” refers to a customer care service agent that may be associated with a customer care service. The second user may be presented with one or more recommendations, based on initiating an establishment of a communicative connection with a server that corresponds to the customer care service. In an embodiment, the first user may establish connection with a second user that may be associated with the server.

A “training” refers to imparting knowledge or skills that pertain to a particular domain of study that include, but are not limited to, science, mathematics, art, literature, language, philosophy, and/or the like.

A “classifier” refers to a mathematical model that may be configured to categorize a subject in one or more categories. In an embodiment, the classifier may be trained based on a historical data associated with the subject. Examples of the one or more techniques that may be utilized to train the classifier include, but are not limited to, a Hidden Markov Model (HMM), a Support Vector Machine (SVM), a Logistic Regression, a Bayesian Classifier, a Decision Tree Classifier, a Copula-based classifier, a K-Nearest Neighbours (KNN) Classifier, a Random Forest (RF) Classifier.

A “temporal data” refers to data associated with the first user. The temporal data may comprise one or more attributes that may evolve temporally over a period of time. The one or more attributes may comprise a country of the first user, a gender of the first user, one or more parameters associated with an emotional state of the first user, one or more of the one or more types of communication channels selected by the first user for establishing a communicative connection between the first user and the server, a causal parameter for establishing of the communicative connection between the first user and the server, a frequency of establishing the communicative connection between the first user and the server, a gender of the first user.

A “likelihood” refers to a probability of selection of a type of communication channel from the one or more types of communication channels, for communication between the first user and the server.

A “pre-determined weight” refers to a parameter that corresponds to a cost of resources required for establishing of a communicative connection based on one or more types of communication channels. A higher value of the pre-determined weight may correspond to a higher cost of a communication channel and a lower value of the pre-determined weight may correspond to a low cost of a communication channel.

A “user interface (UI) object” refers to a user interface element displayed on the display screen of an electronic device. In an embodiment, the UI object may be utilized to render one or more recommendations generated by the application server. In an embodiment, the user interface object may indicate the predicted likelihood, associated with a first user, to communicate with a second user over a communication network. The second user may be associated with a customer care service. In an alternate embodiment, the UI object may indicate the one or more types of communication channels that may be utilized by the second user to initiate/establish a communicative connection with the first user. The second user may interact with the UI object using various input mediums/techniques including, but not limited to, a keypad, mouse, joystick, any touch-sensitive medium (e.g., a touch-screen or touch sensitive pad), voice recognition, gestures, video recognition, and so forth.

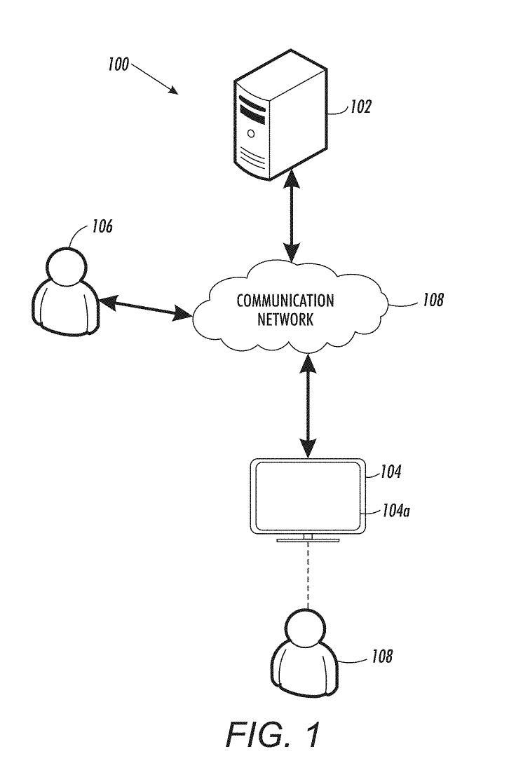

FIG. 1 is a block diagram of a network environment 100, in which various embodiments can be implemented. The network environment 100 includes an application server 102, an electronic device 104, a first user 106, a second user 108, and a communication network 110. The electronic device 104 may comprise a display screen 104a. Various devices in the network environment 100 (e.g., the application server 102 and the electronic device 104) may be interconnected over the communication network 110.

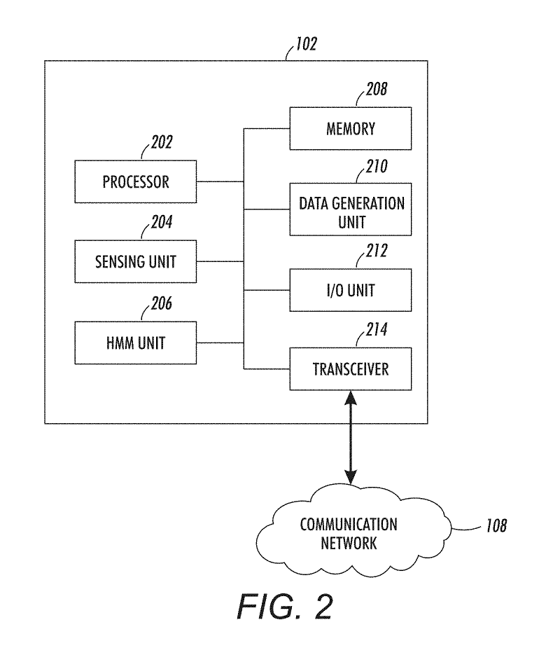

The application server 102 may refer to a computing device or a software framework that may provide a generalized approach to create the application server implementation. In an embodiment, the function of the application server 102 may be dedicated to the efficient execution of procedures, such as, but not limited to, programs, routines, or scripts stored in one or more memories for supporting its applied applications. In an embodiment, the application server 102 may be configured to monitor the communication between the first user 106, the second user 108 associated with the application server 102, and/or the customer care services. In an embodiment, the application server 102 may retrieve temporal data of the first user 106 from a local database associated with the application server 102. Further, the application server 102 may train the classifier based on the monitored and/or the retrieved temporal data. In an embodiment, the application server 102 may be realized through various web-based technologies such as, but not limited to, a Java web-framework, a .NET framework, a PHP framework, or any other web-application framework. The application server 102 has been described in detail in FIG. 2. A person having ordinary skill in the art will appreciate that the scope of the disclosure is not limited to realizing the application server 102 and the electronic device 104 as separate entities. In an embodiment, the application server 102 may be realized as an application program installed on and/or running on the electronic device 104 without departing from the scope of the disclosure.

The electronic device 104 may comprise one or more processors that may be configured to execute one or more sets of instructions stored in the one or more memories associated with the electronic device 104. In an embodiment, the electronic device 104 may be communicatively coupled to the application server 102, via the communication network 110. In an embodiment, the second user 108 may be associated with the electronic device 104. In an embodiment, the electronic device 104 may facilitate the second user 108 in establishing the communication with the first user 106. In an embodiment, the electronic device 104 may be configured to render one or more recommendations generated by the application server 102 (based on the generated temporal data associated with the first user 106) on the display screen 104a. The one or more recommendations may be rendered on the display screen 104a (to the second user 108), via one or more user interface objects. In an embodiment, the electronic device 104 may be further configured to facilitate the second user 108 in establishing the communication between the first user 106 and the application server 102, via one or more types of communication channels. In an embodiment, the display screen 104a may be realized through several known technologies that may include, but are not limited to, a Liquid Crystal Display (LCD) display, a Light Emitting Diode (LED) display, an Organic LED (OLED) display technology, and/or the like. In an embodiment, the electronic device 104 may correspond to various types of computing devices such as, but not limited to, a desktop computer, a laptop, a personal digital assistant (PDA), a mobile device, a smartphone, a tablet computer (e.g., iPad® and Samsung Galaxy Tab®), and the like. For the sake of brevity, only one instance of the electronic device 104 has been used in the disclosure. A person skilled in the art will appreciate that the scope of the disclosure should not be limited to a single instance of the electronic device 104, and that in an embodiment, a plurality of instances of the electronic device 104 may be associated with the network environment 100. Each of the plurality of electronic device 104 may be associated with a user, such as the second user 108.

The first user 106 may correspond to a customer that may establish a communication with the application server 102 and/or the second user 108, via the one or more types of communication channels. In an embodiment, the first user 106 may be associated with one or more attributes. Such one or more attributes may characterize the temporal data that may be generated by the application server 102 based on the monitoring of the established communication. The one or more attributes may include, but are not limited to, a country of the first user, a gender of the first user 106, one or more parameters associated with an emotional state of the first user 106, one or more of the one or more types of communication channels selected by the first user 106, a causal parameter for the establishing of the communication between the first user 106 and the application server 102, a frequency of establishing a communication between the first user 106 and the application server 102. For the sake of brevity, only one instance of the first user 106 has been used in the disclosure. A person skilled in the art will appreciate that the scope of the disclosure should not be limited to a single instance of the first user 106, and that in an embodiment, a plurality of instances of the first user 106 may be associated with the network environment 100.

The second user 108 may correspond to a customer care representative that may be associated with the application server 102. The second user 108 may be further associated with the electronic device 104. Based on the training of the classifier by use of the generated temporal data, the application server 102 may be configured to render the one or more recommendations of the one or more types of communication channels to the second user 108. Such rendering may be performed on the display screen 104a of the electronic device 104. Based on the rendered one or more recommendations the second user 108 may be configured to establish a communication with the first user 106. For the sake of brevity, only one instance of the second user 108 has been used in the disclosure. A person skilled in the art will appreciate that the scope of the disclosure should not be limited to a single instance of the second user 108, and that in an embodiment, a plurality of instances of the second user 108 may be associated with the network environment 100, via the electronic device 104.

The communication network 110 corresponds to a medium utilized by the one or more types of communication channels for establishing communication between the first user 106 and the application server 102 or the second user 108. Examples of the communication network 110 may include, but are not limited to, a Wireless Fidelity (Wi-Fi) network, a Wireless Area Network (WAN), a Local Area Network (LAN), or a Metropolitan Area Network (MAN). Various devices in the network environment 100 can connect to the communication network 110 in accordance with various wired and wireless communication protocols such as Transmission Control Protocol and Internet Protocol (TCP/IP), User Datagram Protocol (UDP), and Global System for Mobile Communication (GSM), Wireless Code Division Multiple access (WCDMA), and/or Long Term Evolution (LTE), communication protocols.

FIG. 2 is a block diagram illustrating the application server 102, in accordance with at least one embodiment. In an embodiment, the application server 102 may include a processor 202, a sensing unit 204, a Hidden Markov Model (HMM) unit 206, a memory 208, a data generation unit 210, an input/output (I/O) unit 212, and/or a transceiver 214. The transceiver 214 may be coupled to the communication network 110.

The processor 202 may be coupled to the sensing unit 204, the HMM unit 206, the memory 208, the data generation unit 210, the I/O unit 212, and/or a transceiver 214. The processor 202 may include suitable logic, circuitry, and/or interfaces that are configured to execute one or more instructions stored in the memory 208 to perform one or more pre-determined operation. The memory 208 may be configured to store the one or more instructions that correspond to the one or more pre-determined operations. The processor 202 may be implemented using one or more processor technologies known in the art. Examples of the processor 202 include, but are not limited to, an x86 microprocessor, a Reduced Instruction Set Computer (RISC) microprocessor, an Application Specific Integrated Circuit (ASIC) microprocessor, a Complex Instruction Set Computer (CISC) microprocessor, or the like.

A person skilled in the art will appreciate that the scope of the disclosure should not be limited to the application server 102 including a single processor. The application server 102 may include more than one microprocessors, which may operate in parallel and perform the one or more pre-determined operations. Further, in an embodiment, the processor 202 may be capable of performing more than one operations in parallel. For example, the processor 202 may be a multi-threaded processor, which may execute more than one threads/processes concurrently. Each such thread/process may be executed to perform a pre-determined operation.

The sensing unit 204 may comprise suitable logic, circuitry, and/or interfaces that may be configured to store a machine code and/or a computer program having at least one code section executable by the processor 202. The sensing unit 204 may comprise one or more sensors that may be configured to monitor the communication among the first user 106, second user, and the application server 102, for a pre-defined time period. The sensing unit 204 may comprise one or more packet analyzers that may be configured to monitor the data that may be exchanged among at least the first user 106, the second user, and the application server 102, in a data stream. In an embodiment, the sensing unit 204 may be configured to transmit the monitored data to the processor 202, via the transceiver 214. Based on the data received from the sensing unit 204, the processor 202 may be configured to generate temporal data that corresponds to the first user 106. In an embodiment, the sensing unit 204 may be realized through several known packet analyzers that include, but are not limited to, wireshark, tcpdump, Nethawk Analyzer, dSniff, Lanmeter, and Microsoft Network Monitor.

The HMM unit 206 may comprise suitable logic, circuitry, and/or interfaces that may be configured to store a machine code and/or a computer program having at least one code section executable by the processor 202. The HMM unit 206 may comprise a classifier that may be based on Hidden Markov Model in which each instance of the first user 106 is assigned a latent state. The latent state may be based on one or more attributes of the temporal data (of the first user 106), generated by the processor 202. In an embodiment, a unique HMM may be created for each of the attributes associated with the data of the first user 106. The HMM unit 206 may be further configured to train the classifier based on the generated temporal data. Based on the training, the HMM unit 206 may be further configured to predict a likelihood of selection of a type of communication channel (by the first user 106) from the one or more types of communication channels, for communication with the application server 102. In an embodiment, the HMM unit 206 may be further configured to transmit the predicted likelihood to the processor 202, via the transceiver 214. In an embodiment, the HMM unit 206 may be further configured to transmit the predicted likelihood directly to the data generation unit 210, via the transceiver 214. Examples of the HMM unit 206 may be implemented based on one or more technologies known in the art that include, but are not limited to, an x86 microprocessor, a RISC microprocessor, an ASIC microprocessor, a CISC microprocessor, or the like.

The memory 208 stores a set of instructions and data. Some of the commonly known memory implementations include, but are not limited to, Read Only Memory (ROM), Hard Disk Drive (HDD), Solid-State Drive (SSD), flash memory, and/or a Secure Digital (SD) card. Further, the memory 208 includes the one or more instructions that are executable by the processor 202 to perform specific operations. It will be apparent to a person having ordinary skill in the art that the one or more instructions stored in the memory 208 enables the hardware of the application server 102 to perform the pre-determined operation.

The data generation unit 210 may comprise suitable logic, circuitry, and/or interfaces that may be configured to store a machine code and/or a computer program having at least one code section executable by the processor 202. The data generation unit 210 may be configured to rank the one or more types of communication channels in a sequence based on the likelihood predicted by the HMM unit 206. The data generation unit 210 may be further configured to transmit the ranked one or more types of communication channels to the processor 202, via the transceiver 214. The data generation unit 210 may be configured to retrieve the pre-determined weights from the memory 208. The retrieved pre-determined weights of the one or more types of the communication channels may correspond to a cost of resources required for establishing communication based on a communication channel of the one or more types of communication channels. The data generation unit 210 may be further configured to recommend one or more communication channels from the one or more types of communication channels, to the second user. The recommendation of the one or more types of communication channels may be based on the pre-determined weights associated with each of the one or more types of communication channels. The data generation unit 210 may be implemented based on one or more technologies known in the art that include, but are not limited to, an x86 microprocessor, a RISC microprocessor, an ASIC microprocessor, a CISC microprocessor, or the like.

The I/O unit 212 may comprise suitable logic, circuitry, interfaces, and/or code that may be configured to render the one or more recommendations on the display screen 104a associated with the electronic device 104. The rendering of the one or more recommendations may be implemented using one or more user interface (UI) objects generated by the I/O unit 212. In an embodiment, the I/O unit 212 may be configured to transmit the generated one or more UI objects to the processor 202, via the transceiver 214. In an embodiment, the I/O unit 212 may be configured to transmit the generated one or more UI objects to the electronic device 104, via the transceiver 214, for rendering on the display screen 104a. In an embodiment, when the electronic device 104 is integrated with the application server 102, the display device may correspond to the display screen 104a of the electronic device 104. Examples of the input devices of the I/O unit 212 may include, but are not limited to, a keyboard, a touch screen, a microphone, a camera, a motion sensor, a light sensor, and/or a docking station. Examples of the output devices of the I/O unit 212 may include, but are not limited to, a display device and/or a speaker. The display device may be configured to receive one or more input actions from the one or more users, such as the second user 108, via a touch-sensitive screen. Such one or more input actions may be received from the second user 108 by means of a virtual keypad, a stylus, touch-based input actions, and/or a gesture. In an embodiment, the touch screen may correspond to at least one of a resistive touch screen, capacitive touch screen, or a thermal touch screen. In an embodiment, the I/O unit 212 may receive an input through a virtual keypad, a stylus, a gesture, and/or touch based input. The display device may be realized through several known technologies such as, but not limited to, Cathode Ray Tube (CRT) based display, Liquid Crystal Display (LCD) display, Light Emitting Diode (LED) display, and/or Organic LED (OLED) display technology, Retina display technology.

The transceiver 214 may comprise suitable logic, circuitry, interfaces, and/or code that may be configured to transmit and receive messages and data to/from various components of the network environment 100 (e.g., the application server 102, and the electronic device 104) over the communication network 110. Further, the transceiver 214 may transmit the generated one or more recommendations corresponding to the training of the classifier to the second user 108. The transceiver 214 may be implemented based on known technologies to support wired or wireless communication of the application server 102 with the electronic device 104, via the communication network 110. The transceiver 214 may include, but is not limited to, an antenna, a frequency modulation (FM) transceiver, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 214 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Long Term Evolution (LTE), Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.120 g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS). Further, the transceiver 214 transmits and receives data/messages in accordance with the various communication protocols such as TCP/IP, UDP, and 2G, 3G, or 4G communication protocols.

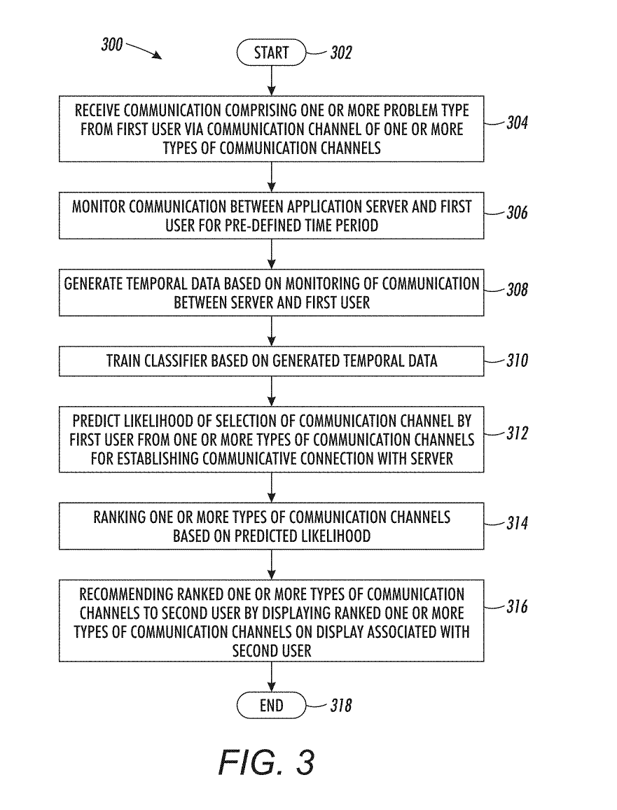

An embodiment of the operation of the application server 102 for training a classifier for communication channel prediction based on monitoring of communication between the first user 106 and the application server 102 has been described in conjunction with FIG. 3.

FIG. 3 is a flowchart 300 illustrating a method for predicting a communication channel for communication between a customer and a customer care agent, in accordance with at least one embodiment. The customer may correspond to the first user 106 (as explained in FIG. 1) and the customer care agent may correspond to the second user (as explained in FIG. 1). The flowchart 300 has been described in conjunction with FIG. 1 and FIG. 2. The flowchart begins at step 302 and proceeds to step 304.

In an embodiment, the application server 102 may be configured to receive a request (from the first user 106) to establish a communication, based on the one or more types of communication channels. Such a request may correspond to a problem encountered by the first user 106, with respect to one or more services offered by the application server 102. In an embodiment, such one or more services may be associated with a product. The one or more problems may correspond to a software and/or a hardware fault in the product offered by the application server 102.

At step 304, communication comprising one or more problem types may be received by the application server 102, via the communication network 110. The communication channel may correspond to a communication channel of the one or more types of communication channels. In an embodiment, the one or more types of communication channels may include, but are not limited to, an e-mail, a mobile based call, a Public Switched Telephone Network (PSTN) call, a software based service request, a software based chat, and a video call. In an embodiment, the received communication may correspond to data exchanged between at least the first user 106 and the application server 102, in a data stream.

At step 306, based on the received communication the sensing unit 204 of the application server 102 may be configured to monitor the communication using one or more sensors. In an embodiment, the monitoring of the communication may be based on the one or more packet analyzers that may be configured to monitor the data that may be exchanged between at least the first user 106 and the application server 102, in a data stream. In an embodiment, the monitoring of the data may be for a pre-defined time period. The pre-defined time period may correspond to a parameter that may be stored in the memory 208. At the time of commencing the monitoring, the sensing unit 204 may be configured to retrieve the parameter from the memory 208. The monitored data may be associated with a timestamp to establish a temporal relation of the monitored data and the time of monitoring.

At step 308, the temporal data may be generated based on the monitored data, by the HMM unit 206. The generation of the temporal data may be based on the pre-defined time period. In an embodiment, the processor 202 may be configured to create a profile of the first user 106 based on the monitored data. The generated temporal data corresponding to the first user 106 may be associated with the created profile of the first user 106. In an embodiment, the generated temporal data may comprise one or more attributes associated with the first user 106. The one or more attributes may include, but are not limited to, a country of the first user 106, a gender of the first user 106, one or more parameters associated with an emotional state of the first user 106, one or more of the one or more types of communication channels selected by the first user 106 for establishing a communication with the application server 102, a causal parameter for establishing of the communication with the application server 102, and a frequency of establishing a communication with the application server 102. In an embodiment, the causal parameter for establishing the communication with the application server 102 may correspond to a problem reported by the first user 106. Further, each of the problems reported by the first user 106 may be categorized into one or more problem types.

In an embodiment, the HMM unit 206 may be configured to create a classifier based on the Hidden Markov Model (HMM) for each of the one or more problem types reported by the first user 106. A person of ordinary skill in the art will appreciate that the HMM based classifier may be created for each of the instance of the first user 106. For example, when the number of instances of the first user is “100”, and when the problem type corresponds to “hardware failure”, an HMM based classifier may be created for the problem type “hardware failure”, for each of the “100” instances of the first user 106.

A person having ordinary skill in the art will further appreciate that the HMM based classifier may be created for one or more attributes of the generated temporal data, for each of the instance of the first user 106. In an embodiment, the HMM unit 206 may be configured to create one or more groups of the instances of the first user 106, based on the created HMM based classifier corresponding to the one or more attributes.

In an embodiment, the first user 106 may be classified based on assignment of a latent state to the first user 106 based on the one or more attributes of the generated temporal data, in accordance with the HMM. The set of assigned latent states may be denoted by the set “S” that may comprise states “S₀ . . . S_{T}”, where “S₀” denotes the latent state of the first user 106 at the commencement of the communication, and “S_{T}” denotes the state of the customer at time “T”. Each of the latent state of the set “S” may correspond to an attribute of the one or more attributes associated with the generated temporal data. For example, a state of the set may correspond to the one or more parameters associated with an emotional state of the first user 106. Further, the HMM unit 206 may be configured to determine a probability of transition of the first user 106 at time “t+1” in accordance with the equation (1). In an embodiment, the probability that the first user 106 may transition to a state j εS at Sₜ₊₁ may depend only on the value of the state at time t and not on any other values in the past.

P(Sₜ₊₁=j|Sₜ,Sₜ₋₁ . . . S₀)=P(Sₜ₊₁=j|sₜ) (1)

where,

jεS.

In an embodiment, the change of state of the first user 106 from one state to another may be based on a selection of a communication channel of the one or more types of communication channels. Such a selection of the communication channel of the one or more types of communication channels may correspond to a stochastic event. The conditional probability of the selection of the communication channel of the one or more types of communication channels may be based on equation (2).

P(cₜ₊₁=k|Sₜ₊₁) (2)

where,
“c” corresponds to a history of communication channels of the one or more types of communication channels selected by the first user 106; and
k corresponds to a communication channel from the one or more communication channels.

In an embodiment, all the probability values of transition from one latent state to another state of the first user may be represented by a “matrix T” where the each entry of the matrix may correspond to a probability of transition from the row state to the column state. Further, the probability of selection of a communication channel of the one or more types of communication channels corresponding to a latent state may be represented by a “matrix O” where each entry corresponds to a probability of observing a communication channel given the latent state. The two matrices “T” and “O” represent the parameters of the HMM.

At step 310, the HMM unit 206 may be configured to train the HMM based classifier based on the temporal data that comprises sequences of communication channels selected by the first user 106 at various instants of time. Further, an Expectation Maximization technique that is known in the art (that may be stored in the memory 208) may be used to learn the parameters of HMM based classifier. In an embodiment, the parameters may be utilized alternatively to estimate the latent states and utilize the latent states to estimate the parameters.

At step 312, the HMM unit 206 may be configured to predict a first likelihood that corresponds to a probability of establishing a communication with the application server 102, by the first user 106. The HMM unit 206 may be further configured to predict a second likelihood of selection of a communication channel (for establishing communication with the application server 102) from the one or more types of communication channels, by the first user 106. The prediction of the first likelihood and/or the second likelihood may be based on the trained HMM based classifier. In case of cessation of the communication of the first user 106 with the application server 102, the probability (and hence, the first likelihood) of the first user 106 to communicate with the application server 102 may be determined to be zero. Further, the history of selection of communication channels “C₁, C₂, C₃, . . . Cₜ” may be monitored, by the HMM unit 206 for the prediction of the second likelihood. Further, a transition probability and/or an observation probability may be determined based on the transition “matrix T” and the observation “matrix O”, respectively. The predicted likelihood may be further based on the determined transition probability and/or an observation probability.

In an embodiment, the accuracy of the predicted first likelihood and/or the second likelihood may be determined by the processor 202 based on a count of instances where the predicted selection of the communication channel (from the one or more types of communication channels) is correct. In an embodiment, the predicted first likelihood and/or the second likelihood may be communicated (by the HMM unit 206) to the data generation unit 210, via the transceiver 214. In an alternate embodiment, the predicted first likelihood and/or the second likelihood may be communicated to the processor 202, which may command the data generation unit 210 to perform one or more operations based on the predicted likelihood.

At step 314, based on the predicted second likelihood the data generation unit 210 may be configured to rank the one or more types of communication channels. In an embodiment, ranking of the one or more types of communication channels may be based on a sequence that may correspond to an ascending order of the second likelihood of the communication channels of the one or more types of communication channels. In an embodiment, ranking of the one or more types of communication channels may be based on a sequence that may correspond to a descending order of the second likelihood of the communication channels of the one or more types of communication channels.

At step 316, the data generation unit 210 may be configured to generate recommendations corresponding to the ranked one or more communication channels of the one or more types of communication channels for the second user 108. In an embodiment, the generated recommendations may be based on a pre-determined weight associated with each of the one or more types of communication channels. The pre-determined weight may be stored in the memory 208. In an embodiment, the data generation unit 210 may be configured to retrieve the pre-determined weights of each of the one or more types of communication channels from the memory 208. The pre-determined weights may be indicative of a cost of a using a communication channel to establish a communication between the first user 106 and the application server 102. The cost may be determined based on at least the number and/or a type resources required to establish the communication. For example, the cost of communication channels such as a PSTN call may be high, as a PSTN call requires a dedicated human resource for establishing and using the communication channel. Similarly, the cost of an automated communication channel, such as an Interactive Voice Response System (IVRS) based call, may be low as no human intervention is required to establish and use the communication.

In an embodiment, the data generation unit 210 may be configured to communicate the first likelihood, the ranked one or more communication channels and/or the generated one or more recommendations to the I/O unit 212. A person having ordinary skill in the art will appreciate that the data generation unit 210 may be configured to communicate the first likelihood, the ranked one or more communication channels and/or the generated one or more recommendations to one or more other components of the application server 102. The one or more other components may be configured to perform one or more operations based on the received ranked one or more communication channels and/or the generated one or more recommendations.

In an embodiment, the I/O unit 212 may be configured to generate one or more UI objects that correspond to the first likelihood, the received ranked one or more communication channels and/or the generated one or more recommendations. The I/O unit 212 may be further configured to transmit the generated one or more UI objects to the electronic device 104, via the transceiver 214.

In an alternate embodiment, when the electronic device 104 is integrated with the application server 102, the I/O unit 212 may be configured to render the generated one or more UI objects on the display screen 104a, to the second user 108. In an instance of the embodiment, the I/O unit 212 may be configured to receive one or more inputs provided by the second user 108 on the display screen 104a. Such one or more inputs may correspond to the rendered the first likelihood, the ranked one or more communication channels and/or the generated one or more recommendations. For example, the second user 108 may provide an input that may correspond to a selection of a communication channel, such as an e-mail, from the ranked one or more communication channels, for establishing communication with the first user 106. Based on the generated recommendations, the second user 108 may further transmit the notification to the first user 106 to use a specific channel (that corresponds to a low pre-determined weight) for establishing communication with the application server 102.

A person having ordinary skill in the art will appreciate that the first likelihood, the received ranked one or more communication channels and/or the generated one or more recommendations may be rendered to the second user by using an audio interface associated with the electronic device 104.

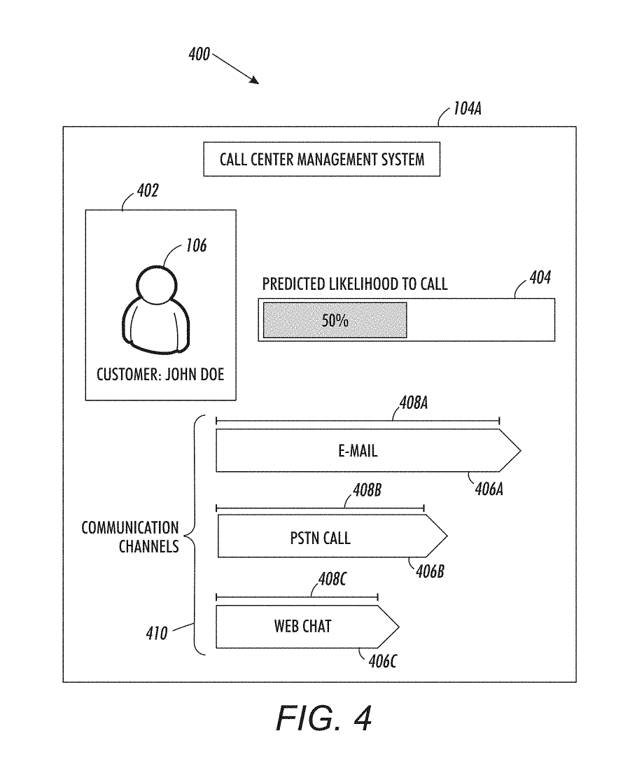

FIG. 4 is an exemplary UI 400 illustrating prediction of a communication channel for communication between a customer and a customer care agent, in accordance with at least one embodiment. The exemplary UI 400 has been described in conjunction with FIG. 1, FIG. 2, and FIG. 3.

With reference to FIG. 4, there are shown one or more UI objects generated by the application server 102. In an exemplary scenario, based on the training of the HMM based classifier using the temporal data associated with the first user 106, the application server 102 may be configured to generate the one or more UI objects. The generated one or more UI objects may be rendered on the display screen 104a.

In an instance of the exemplary scenario, the generated one or more UI objects may comprise a UI object 402 that corresponds to the first user 106. The one or more UI objects may further comprise the UI object 404 that corresponds to the predicted first likelihood. The predicted first likelihood may be indicative of a probability of establishing a communication with the application server 102, by the first user 106. For example, the predicted likelihood of receiving a call from the first user 106 is 50%. The generated one or more UI objects may further comprise the UI objects 406a, 406b, and/or 406c that may correspond to the communication channels, such as e-mail, PSTN call, and web chat, respectively. A person having ordinary skill in the art will appreciate that one or more UI objects other than the generated UI objects that correspond to the one or more other communication channels (of the one or more types of communication channels) may be rendered on the display screen 104a.

In an instance of the exemplary scenario, the generated one or more UI objects 406a, 406b, and 406c, corresponding to the communication channels may be characterized by sizes 408a, 408b, and 408c, of the UI objects. The sizes 408a, 408b, and 408c may be indicative of the second likelihood predicted by the HMM unit 206 of the application server 102 (as explained in FIG. 3). In an instance of the exemplary scenario, the bigger size of the UI object 406a with respect to the size of the UI object 406b indicates a higher likelihood of the first user 106 of using the e-mail as a communication channel to establish the communication with the application server 102, compared with PSTN call. Similarly, the bigger size of the UI object 406b with respect to the size of the UI object 406c indicates a higher likelihood of the first user 106 of using the PSTN call as a communication channel to establish the communication with the application server 102, compared with web chat.

In an instance of the exemplary scenario, based on the predicted second likelihood, the I/O unit 212 of the application server 102 may be configured to arrange the UI objects 406a, 406b, and 406c corresponding to the communication channels in a sequence 410. A person having ordinary skill in the art will appreciate that one or more other ways may be used by the I/O unit 212 to depict predicted second likelihood of each of the one or more communication channel of the one or more types of communication channels.

The disclosed embodiments encompass numerous advantages. Various embodiments of the disclosure lead to a method and a system for training a classifier for communication channel prediction. Through various embodiments of the disclosure, one or more sensors in a server may monitor a communication involving at least a first user for a pre-defined time period. The one or more types of communication channels being used by at least the first user over the pre-defined time period and/or the one or more types of problems reported by at least the first user, is monitored. The one or more processors of the server may generate a temporal data based on the monitoring. The classifier is trained by the one or more processors, based on the generated temporal data. The classifier predicts a likelihood of selection of a type of communication channels from the one or more types of communication channels, for communication between the first user and the server. This method enables the customer care service provider to predict the propensity (first likelihood) of a customer call. Further, the method enables the customer care service provider to predict a second likelihood that corresponds to a preferred channel from the one or more types of communication channels that may be selected the customer for establishing the communication. Further, the classifier used by the method corresponds to an HMM based classifier. The HMM based classifier is trained based on temporally evolving data associated with the customer, to accurately predict the propensity (first likelihood) of a customer call and/or the preferred communication channel of the customer.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic.” Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for training a classifier for communication channel prediction have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for prediction of a communication channel for communication with a customer service, said method comprising:
monitoring, by one or more sensors in a server, communication involving at least a first user for a pre-defined time period, wherein said monitoring comprises monitoring at least one or more types of communication channels being used by at least said first user over said pre-defined time period and/or one or more types of problems reported by at least said first user;
generating, by one or more processors in said server, a temporal data based on said monitoring; and
training, by said one or more processors in said server, a classifier based on said generated said temporal data, wherein said classifier predicts a likelihood of selection of a type of communication channels from said one or more types of communication channels, for communication between said first user and said server.

2. The method according to claim 1, wherein said one or more types of communication channels are ranked, by said one or more processors of said server, in a sequence based on said predicted likelihood.

3. The method according to claim 1, wherein a communicative connection is established, by said one or more processors of said server, with said first user based on a pre-determined weight associated with each of said one or more types of communication channels.

4. The method according to claim 3, wherein said pre-determined weight corresponds to a cost of resources required for said establishing of said communicative connection based on said one or more types of communication channels.

5. The method according to claim 4, further comprising recommending, by said one or more processors of said server, one or more types of communication channels, to a second user, for said establishing of said communicative connection.

6. The method according to claim 5, wherein said recommendation of said one or more types of communication channels is based on said pre-determined weight.

7. The method according to claim 5, further comprising generating, by said one or more processors of said server, one or more user interface (UI) objects for displaying said recommendation of said one or more types of communication channels, to said second user.

8. The method according to claim 1, wherein said classifier corresponds to a Hidden Markov Model (HMM).

9. The method according to claim 1, wherein said temporal data comprises one or more attributes that correspond to one or more of: a country of said first user, a gender of said first user, one or more parameters associated with an emotional state of said first user, one or more of said one or more types of communication channels selected by said first user for establishing a communicative connection between said first user and said server, a causal parameter for said establishing of said communicative connection between said first user and said server, a frequency of establishing of a communicative connection between said first user and said server.

10. The method according to claim 1, wherein said classifier is created at least for each of said one or more types of problems reported by said first user.

11. The method according to claim 1, wherein said one or more types of communication channels correspond to one or more of: an e-mail, a mobile based call, a Public Switched Telephone Network (PSTN) call, a software based service request, a software based chat, a video call.

12. A system for prediction of a communication channel for communication with a customer service, said system comprising:
one or more processors in a server, said one or more processors configured to:
monitor, based on one or more sensors in communicatively coupled to said one or more processors, communication involving at least a first user for a pre-defined time period, wherein said monitoring comprises monitoring at least one or more types of communication channels being used by at least said first user over said pre-defined time period and/or one or more types of problems reported by at least said first user;
generate a temporal data based on said monitoring; and
train a classifier based on said generated said temporal data, wherein said classifier predicts a likelihood of selection of a type communication channels from said one or more types of communication channels, for communication between said first user and said server.

13. The system according to claim 12, wherein said one or more processors of said server are further configured to rank said one or more types of communication channels in a sequence based on said predicted likelihood.

14. The system according to claim 12, wherein said one or more processors of said server are further configured to establish a communicative connection with said first user based on a pre-determined weight associated with each of said one or more types of communication channels.

15. The system according to claim 14, wherein said pre-determined weight corresponds to a cost of resources required for said establishing of said communicative connection based on said one or more types of communication channels.

16. The system according to claim 14, wherein said one or more processors of said server are further configured to recommend one or more types of communication channels, to a second user, for said establishing of said communicative connection.

17. The system according to claim 16, wherein said recommendation of said one or more types of communication channels is based on said pre-determined weight.

18. The system according to claim 16, wherein said one or more processors of said server further configured to generate one or more user interface (UI) objects for displaying said recommendation of said one or more types of communication channels, to said second user.

19. The system according to claim 12, wherein said classifier corresponds to a Hidden Markov Model (HMM).

20. A non-transitory computer readable storage medium having stored thereon, a program having classifier corresponds at least one code section executable by a computer, thereby causing the computer to perform steps for prediction of a communication channel for communication with a customer service, said steps comprising:
monitoring, by one or more sensors in a server, communication involving at least a first user for a pre-defined time period, wherein said monitoring comprises monitoring at least one or more types of communication channels being used by at least said first user over said pre-defined time period and/or one or more types of problems reported by at least said first user;
generating, by one or more processors in said server, a temporal data based on said monitoring; and
training, by said one or more processors in said server, a classifier based on said generated said temporal data, wherein said classifier predicts a likelihood of selection of a type of communication channels from said one or more types of communication channels, for communication between said first user and said server.
